(19) United States
(12) Patent Application Publication
(10) Pub. No.: US 2014/0121391 A1
(43) Pub. Date: May 1, 2014

(54) VARIABLE PRESSURE PLANT ESSENTIAL OIL EXTRACTION DEVICES AND METHODS

(71) Applicant: Robert Murphy, Golden, CO (US)

(72) Inventor: Robert Murphy, Golden, CO (US)

(21) Appl. No.: 14/067,628

(22) Filed: Oct. 30, 2013

Related U.S. Application Data
(60) Provisional application No. 61/720,193, filed on Oct. 30, 2012.

(51) Int. Cl. C11B 3/00

(52) U.S. Cl. CPC C11B 3/006
USPC 554/8

(57) ABSTRACT

Methods for extracting solute from plant biomass, some examples comprising placing plant biomass in extraction chambers, introducing extraction solvent into the extraction chambers to produce first mixtures, sealing the extraction chambers at predetermined initial pressures, performing pressure adjustment procedures on the first mixtures, the pressure adjustment procedure including introducing pressure gas into the extraction chambers and removing at least a portion of the pressure gas from the extraction chambers, repeating the pressure adjustment procedure, and discarding plant biomass to produce third mixtures. Some examples include introducing transfer oils and removing extraction solvents to produce essential oil mixtures containing transfer oils and extracted solutes. In some examples, an extraction chamber containing plant biomass and a quantity of extraction solvent is provided. In some examples, the pressure adjustment procedure is repeated a predetermined number of times; in others, the pressure adjustment procedure is repeated for a predetermined duration.

### CROSS REFERENCE TO RELATED APPLICATIONS

This application claims priority to copending U.S. Provisional Application Ser. No. 61/720,193, filed on Oct. 30, 2012, which is hereby incorporated by reference for all purposes.

### BACKGROUND

The present disclosure relates generally to plant essential oil extraction devices and methods. In particular, variable pressure plant essential oil extraction devices and methods are described.

Essential oils are useful in a variety of applications. For example, essential oils are used as aromatic ingredients in perfumes, cosmetics, and soaps. Further, essential oils are used as food flavoring oils. Additionally, essential oils have various medicinal applications. Extracting essential oils from plants is a common way to obtain essential oils.

Known plant essential oil extraction devices and methods are not entirely satisfactory for the range of applications in which they are employed. For example, existing extraction devices are comprised of expensive extraction equipment and often require high-temperatures to extract essential oils. High temperatures can degrade the quality of essential oils extracted from plants and/or promote unwanted side-reactions. In addition, conventional essential oil extraction devices and methods are time and labor intensive. Further, presently known extraction methods result in low essential oil yield relative to plant biomass.

Thus, there exists a need for plant essential oil extraction devices and methods that improve upon and advance the design of known plant essential oil extraction devices. In particular, plant essential oil extraction devices that allow high-yield essential oil extraction using readily available equipment and solvents are needed. Examples of new and useful plant essential oil extraction devices and methods relevant to the needs existing in the field are discussed below.

### SUMMARY OF THE INVENTION

This disclosure discusses devices and methods for extracting solute from plant biomass. Some method examples comprising placing plant biomass in extraction chambers, introducing extraction solvent into the extraction chambers to produce first mixtures, sealing the extraction chambers at predetermined initial pressures, performing pressure adjustment procedures on the first mixtures, the pressure adjustment procedure including introducing pressure gas into the extraction chambers and removing at least a portion of the pressure gas from the extraction chambers, repeating the pressure adjustment procedure, and discarding plant biomass to produce third mixtures. Some examples include introducing transfer oils and removing extraction solvents to produce essential oil mixtures containing transfer oils and extracted solutes.

In some examples, an extraction chamber containing plant biomass and a quantity of extraction solvent is provided. In some examples, the pressure adjustment procedure is repeated a predetermined number of times; in others, the pressure adjustment procedure is repeated for a predetermined duration.

### BRIEF DESCRIPTION OF THE DRAWINGS

FIG. 1 is a perspective view of an example of a plant essential oil extraction device.

FIG. 2 is a perspective, exploded view of the plant essential oil extraction device shown in FIG. 1 depicting internal components of the device.

FIG. 3 is a perspective, exploded view of the plant essential oil extraction device shown in FIG. 1 depicting the interior of an extraction chamber of the device and internal components of the device.

FIG. 4A is a top perspective view of the plant essential oil extraction device shown in FIG. 1 depicting the device in an unsealed configuration and containing a first mixture including plant biomass and an extraction solvent.

FIG. 4B is a top perspective view of the plant essential oil extraction device shown in FIG. 1 depicting the device in a sealed configuration and connected to a pressure gauge and a pressure gas source.

FIG. 5 includes three depictions of the plant essential oil extraction device shown in FIG. 1 depicting the device in a pre-pressure gas configuration, a pressurized configuration, and an expanded configuration.

FIG. 6 depicts a mixture of plant biomass, extraction solvent, and extracted solute being passed through a filter and into a mixing vessel to discard the plant biomass.

FIG. 7 depicts a container of the device shown in FIG. 1 including a separated mixture of the extraction solvent and an essential oil mixture.

FIG. 8 is a flow diagram depicting a method of extracting essential oils from plants.

### DETAILED DESCRIPTION

The disclosed plant essential oil extraction devices and methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of plant essential oil extraction device and method examples are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

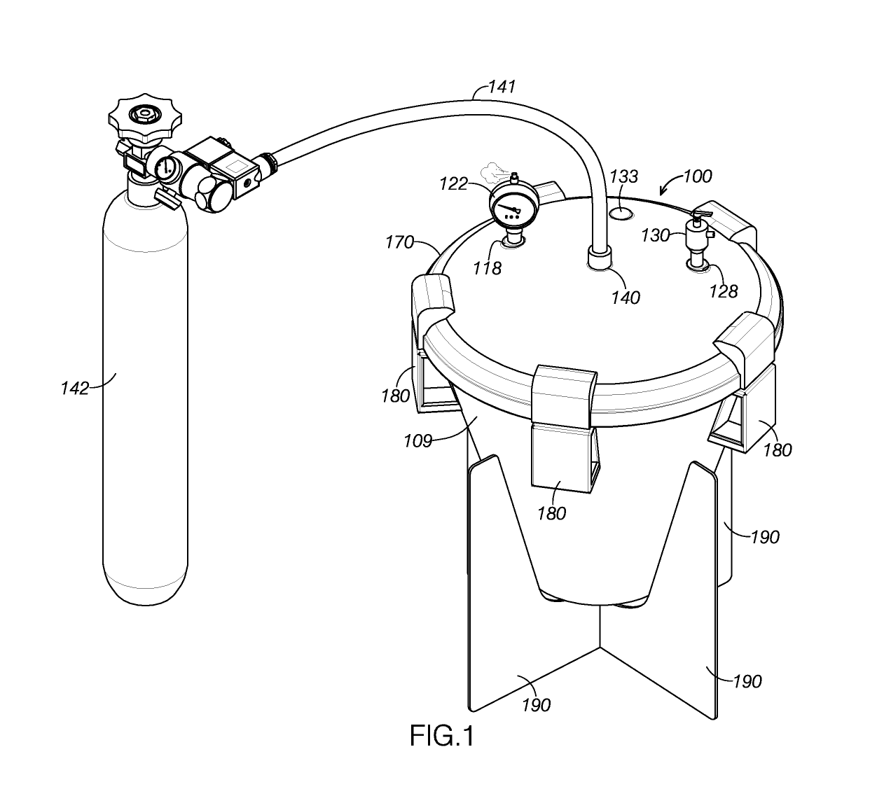

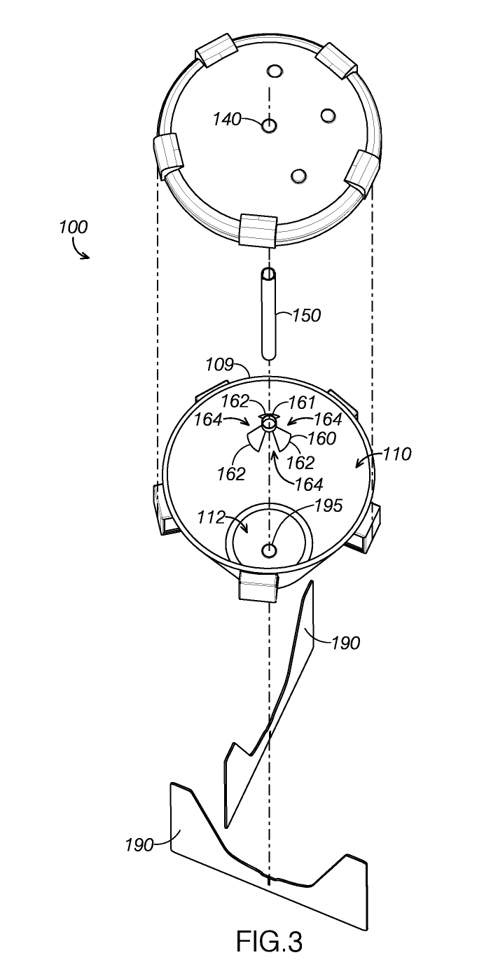

With reference to FIGS. 1-5, an example of a plant essential oil extraction device, device 100, will be described. As FIG. 1 shows, device 100 includes an extraction container 109, a lid 170, lid-retaining members 180, and stabilizing members 190. As FIG. 3 illustrates, device 100 additionally includes a fluid-tight pressure gas conduit 150, a pressure gas dispersal member 160, and a drain port 195. As FIG. 3 further shows, extraction container 109 defines an extraction chamber 110 within its interior.

The various components of device 100 may be comprised of any pressure-resilient and solvent-resistant material including, but not limited to, metals, high-impact plastics, ceramics, composites, and wood. Moreover, device 100 is configured to quickly and easily assemble and, conversely, quickly and easily disassemble for cleaning and transport. Accordingly, device 100 is portable and well-adapted for use in remote locations away from professional production facilities.

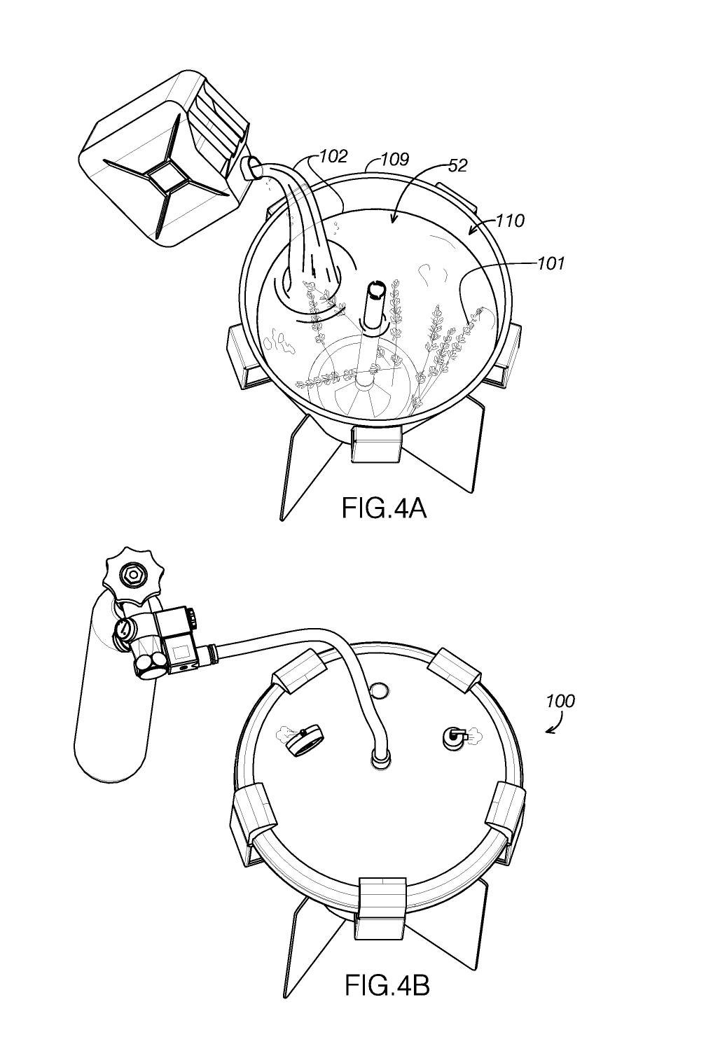

As can be seen in FIG. 3, extraction chamber 110 is disposed within the interior of extraction container 109. As FIG. 4A illustrates, extraction container 109, configured to receive plant biomass and extraction solvent.

Extraction chamber 110 may be comprised of any pressure-resilient and solvent-resistant material including, but not limited to, metals, high-impact plastics, ceramics, composites, and wood. Extraction chamber 110 may additionally or alternatively be made of a rigid, pressure-resistant material that resists deformities at low vacuum pressures or high pressures. Pressures used in the disclosed methods may range from 0 psi to 25 psi in some examples; extraction chamber 110 is configured to maintain its structure and resist deformation through this range of pressures.

Extraction container 109 is fluid-tight. Accordingly, extraction container 109 allows fluid to pass in and out of extraction chamber 110 only through the open top of extraction container 109. As FIG. 4A illustrates, extraction container 109 is sized to receive a lid over its open top to further regulate the passage of fluid in and out of extraction chamber 110.

As FIG. 3 illustrates, extraction container 109 defines a bottom surface 112 disposed at the bottom of extraction chamber 110. As FIG. 3 further illustrates, extraction container 109 further defines a drain port 195 on bottom surface 112.

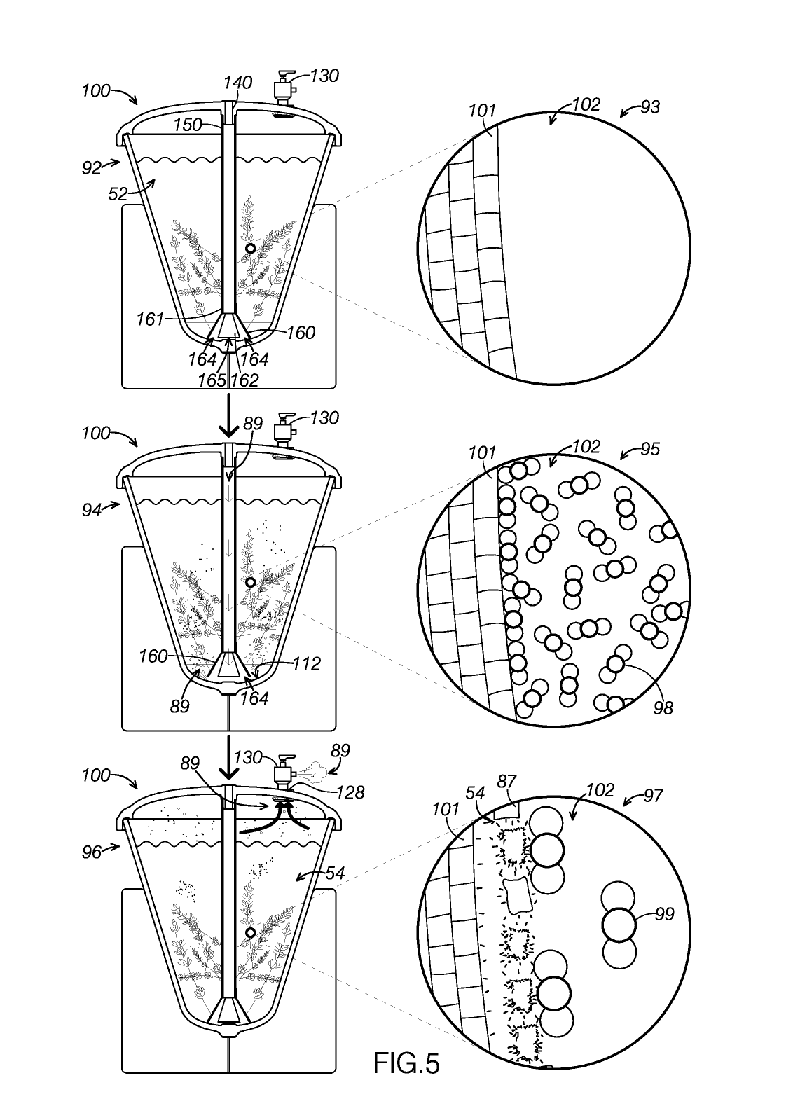

Drain port 195 facilitates or allows extraction solvent to be removed quickly and easily from extraction chamber 110 after essential oil extraction is complete. As FIGS. 3 and 5 illustrate, bottom surface 112 is angled to funnel fluid toward drain port 195. Because drain port 195 is disposed at the bottom of extraction chamber 110, drain port 195 is suitably positioned to drain fluid disposed proximate the bottom of extraction chamber 110.

In particular, when the fluid separates into different layers because of density differences, drain port 195 is positioned to drain relatively dense fluid layers disposed at the bottom of extraction chamber 110 as relatively light fluid layers remain proximate the top of extraction chamber 110. This may be particularly suitable for draining a relatively dense essential oil as relatively light extraction solvents remain spaced from drain port 195 and above the relatively dense essential oil.

Drain port 195 may be comprised of any now known or later developed pressure-resistant, selectively fluid-sealable combination including, but not limited to, drain ports commonly found on conventional drains. Suitable selectively fluid-sealable combinations may include cap-and-thread, plug-and-thread, or latch designs.

As seen in FIG. 1, lid 170 is configured to selectively integrate with extraction chamber 110. As FIG. 1 shows, lid 170 includes a pressure gauge receiver 118, a pressure release receiver 128, a pressure safety release receiver 133, and a pressure gas inlet 140. As FIGS. 1 and 5 show, lid 170 is configured to be fit over the open top of extraction container 109. When so fitted, lid 170 defines a substantially fluid-tight covering, configured to selectively allow passage of fluid in and out of extraction chamber 110 only through pressure gauge receiver 118, pressure release receiver 128, pressure safety release receiver 133, and pressure gas inlet 140, or devices connected thereto. Accordingly, lid 170 defines a fluid-regulating barrier that allows a plurality of optional pressure-regulating elements to attach to the fluid-regulating barriers.

As depicted in FIG. 1, lid 170 is configured to couple with lid-retaining members 180 integrated with extraction container 109. Further, extraction chamber 110 is configured to selectively integrate with lid 170, such that lid 170 may be selectively integrated with lid-retaining members 180, to selectively seal extraction chamber 110 to facilitate extracting plant essential oils.

Alternatively, lid-retaining members 180 may be integrated with lid 170. Lid-retaining members may be comprised of any now known or later developed retaining structure including, but not limited to, clamps, wing nut/bolt combinations, screw-and-thread, and hook-and-loop structures.

As FIG. 1 shows, pressure gauge receiver 118, pressure release receiver 128, pressure safety release receiver 133, and pressure gas inlet 140 are each integrated within lid 170. Pressure gauge receiver 118, pressure release receiver 128, pressure safety release receiver 133, and pressure gas inlet 140 each selectively allow the passage of fluid in and out of extraction chamber 110, thereby serving, with drain port 195, as the only potential points through which fluid may pass in and out of extraction chamber 110. Accordingly, pressure gauge receiver 118, pressure release receiver 128, pressure safety release receiver 133, and pressure gas inlet 140 (and devices connected thereto) may be used, either individually or collectively, to regulate the pressure within extraction chamber 110.

As FIG. 1 shows, pressure gauge receiver 118 is configured to selectively receive a complimentarily configured pressure gauge, such as pressure gauge 122. Pressure gauge 122 is configured to read the pressure within extraction chamber 110. Pressure gauge 122, in some examples, may allow fluid from extraction chamber 110 to pass through it. In such configurations, pressure gauge 122 may be used to remove gas from extraction chamber 110 to adjust the internal pressure of extraction chamber 110 to a predetermined lower pressure.

In some examples, pressure gauge 122 may be configured for automatic operation. For example, pressure gauge 122 may restrict fluid from passing in and out of extraction chamber 110 when the read pressure is below a threshold pressure and/or allow fluid to pass in and out of extraction chamber 110 when the read pressure is above a threshold pressure.

Pressure release receiver 128 is configured to selectively couple with a complimentarily configured pressure release valve, such as pressure release valve 130. Pressure release valve 130 is configured to selectively allow the passage of fluid from extraction chamber 110. Accordingly, pressure release valve 130 may be opened to remove gas from extraction chamber 110 to adjust the internal pressure extraction chamber 110 to a predetermined lower pressure.

Pressure safety release receiver 133 is configured to automatically open to allow pressurized gas to exit from the extraction chamber if the interior of the extraction chamber exceeds a predetermined maximum pressure.

Pressure gas inlet 140 is configured to fluidly couple with a pressure gas source, such as pressure gas source 142. When attached, the pressure gas source is configured to open pressure gas inlet 140 to allow fluid to pass through pressure gas inlet 140 and into extraction chamber 110. For example, pressure gas source 142 may be connected to pressure gas inlet 140 via a hose 141 that includes a tip configured to open pressure gas inlet 140 when inserted through pressure gas inlet 140. When pressure gas inlet 140 is closed and no pressure gas source has been received in pressure gas inlet 140, it is configured to restrict the passage of fluid in and out of extraction chamber 110.

As FIGS. 3 and 5 illustrate, pressure gas conduit 150 is selectively integrated with pressure gas inlet 140 on the interior surface of lid 170. More precisely, pressure gas conduit 150 is sized to slidingly couple with a projection extending from pressure gas inlet 140, thereby allowing fluid passed through pressure gas inlet 140 to be fluidly communicated through pressure gas conduit 150. As FIGS. 3 and 5 show, pressure gas conduit 150 is in fluid communication with a pressure gas source when the pressure gas source is inserted within pressure gas inlet 140.

As FIG. 3 illustrates, pressure gas conduit 150 is selectively attached to lid 170. Accordingly, pressure gas conduit 150 may be attached in contexts where a user desires the pressure gas to enter extraction chamber 110 proximate bottom surface 112. Pressure gas conduit 150 may be removed in contexts where a user desires pressure gas to enter extraction chamber 110 proximate lid 170.

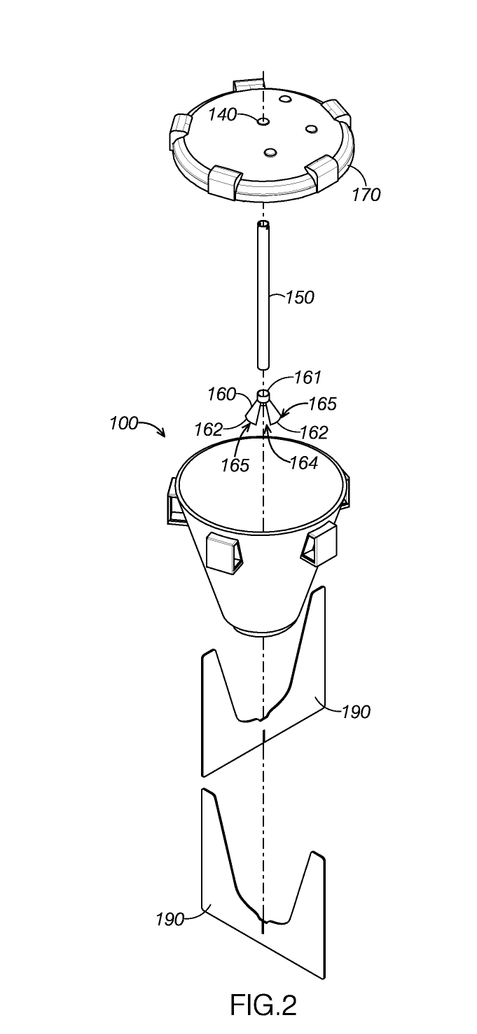

As FIGS. 3 and 5 similarly show, dispersal member 160 is selectively integrated with pressure gas conduit 150 on the end of pressure gas conduit 150 distal lid 170. More precisely, dispersal member 160 defines a projection that slidingly couples with pressure gas conduit 150 at its end proximate bottom surface 112. As FIGS. 2 and 3 show, dispersal member 160 defines a conduit fitting 161, a plurality of supporting members 162 and a plurality of dispersal openings 164. Dispersal member 160 directs fluid from pressure gas conduit 150 to the bottom of extraction chamber 110 while stably supporting pressure gas conduit 150 in a substantially fixed position between bottom surface 112 and lid 170.

As FIGS. 3 and 5 show, conduit fitting 161 is configured to slidingly and fluid-tightly couple with pressure gas conduit 150 to place dispersal member 160 in fluid communication with pressure gas conduit 150. Because pressure gas conduit 150 is slidingly coupled with both pressure gas inlet 140 and dispersal member 160, it is slidingly adjustable to a position where it is fluid-tightly coupled with lid 170 and dispersal member 160 when lid 170 is fitted over the top opening of extraction container 109.

As FIGS. 3 and 5 show, supporting members 162 define rigid members that extend from conduit fitting 161 at obtuse angles. As FIG. 5 illustrates, supporting members 162 each define a supporting edge 165 configured to rest on bottom surface 112 to support dispersal member 160 in a substantially fixed, upright position over drain port 195.

As FIGS. 3 and 5 show, dispersal openings 164 each define gaps between supporting members 162, each gap being configured to pass fluid received from pressure gas conduit 150 into the extraction chamber.

As can be seen in FIG. 1, stabilizing members 190 may be selectively integrated with extraction chamber 110 to facilitate stabilizing device 100. As FIGS. 1 and 2 show, stabilizing members 190 are substantially identical and are configured to slidingly receive an opposite paired stabilizing member to create a four-legged support for extraction container 109. Stabilizing members 190 may be comprised of any now known or later developed material including, but not limited to metals, wood, plastics, or composite materials.

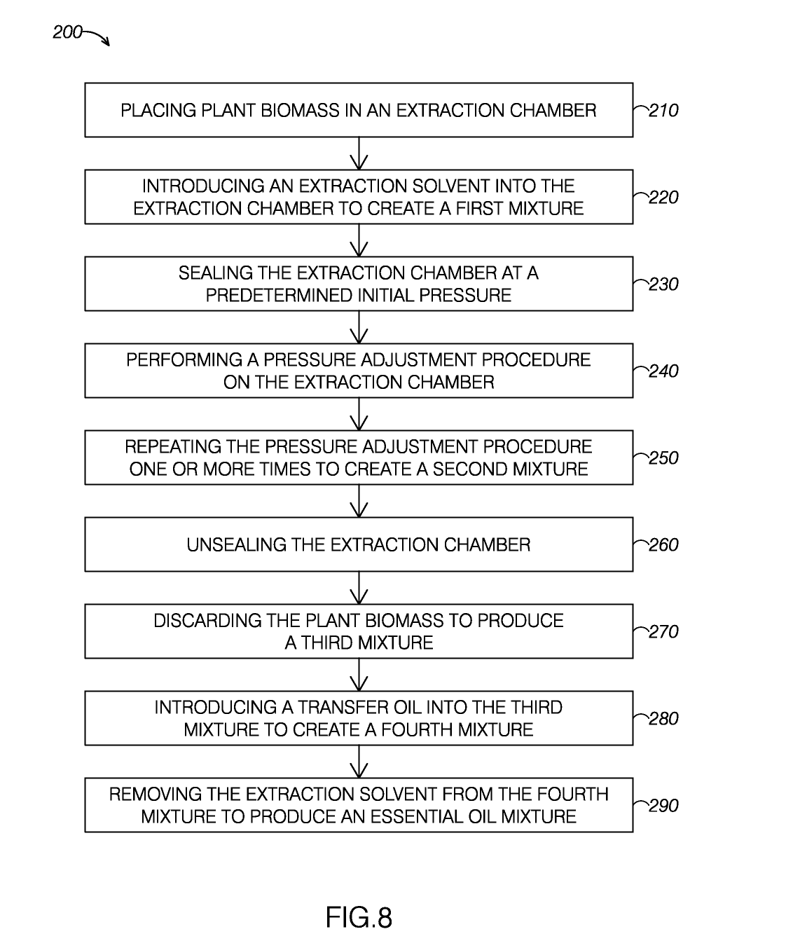

Turning attention to FIG. 8, a method 200 of using plant essential oil extraction device 100 will now be described. Method 200 uses repetitive fluctuating pressure to rupture plant structural components, including cell walls and trichomes; thus, more efficiently extracting essential oils from plant biomass. Method 200 includes placing plant biomass in the bottom of the extraction chamber 110 at step 210, introducing an extraction solvent into extraction chamber 110 to create a first mixture at step 220, and sealing the extraction chamber at a predetermined initial pressure at step 230. As FIG. 8 shows, method 200 further includes performing a pressure adjustment procedure on the extraction chamber at step 240, repeating the pressure adjustment procedure one or more times or for a predetermined duration at step 250, and unsealing the extraction chamber to expose the second mixture to atmospheric pressure at step 260. As seen in FIG. 8, method 200 additionally includes discarding the plant biomass to produce a third mixture at step 270, introducing a transfer oil into the third mixture to create a fourth mixture at step 280, and removing the extraction solvent from the fourth mixture to produce an essential oil mixture at step 290.

In some examples, the extraction solvent is discarded, and the transfer oil layer containing the desired plant essential oil mixture is retained. This essential oil mixture containing the plant essential oils may be considered ready for use.

As FIG. 8 shows, plant biomass is placed in the bottom of extraction chamber 110 at step 210. FIG. 4A illustrates an example of plant biomass, lavender 101, deposited within extraction chamber 110.

As seen in FIG. 4A, an extraction solvent 102 is introduced into the interior of extraction chamber 110 to create a first mixture 52, the first mixture including the plant biomass and the extraction solvent at step 220. Acceptable extraction solvents may include alcohol-based solutions, such as ethanol, methanol, etc. In some examples, introducing the extraction solvent into extraction chamber 110 includes pouring extraction solvent into extraction chamber 110, though extraction solvent could additionally or alternatively be introduced via an inlet in lid 170, such as pressure gas inlet 140. In some examples, introducing the extraction solvent includes completely or partially submerging the plant biomass in extraction chamber 110 with extraction solvent by pouring a quantity of extraction solvent sufficient to completely or substantially submerge the plant biomass contained in extraction chamber 110.

As seen in FIG. 8, the extraction chamber is sealed at a predetermined initial pressure at step 230. In some examples, sealing the extraction chamber includes fitting a substantially fluid-tight lid, such as lid 170, over the top of the extraction chamber. In some examples, lid 170 may be configured to couple with lid-retaining members 180 integrated with a paired extraction container 109. In such examples, sealing the extraction chamber may include coupling lid 170 with lid-retaining members 180 to secure lid 170 to extraction container 109.

As FIG. 8 illustrates, a pressure adjustment procedure is performed on extraction chamber 110 at step 240. The pressure adjustment procedure includes adjusting the pressure within extraction chamber 110 upwards to compress pressure gas and/or extraction solvent molecules to a predetermined compression amount. The pressure adjustment procedure also includes releasing gas from extraction container 109 when pressurized to expand molecules bound to the plant biomass to rupture the plant biomass and extract solute therefrom. The disclosed pressure adjustment procedures may be particularly adaptable to rupturing plant cell walls and trichomes.

The pressure being released may cause compressed molecules bound to the plant biomass to expand and rupture the structural materials of the bound plant. Molecules bound to the plant biomass may include compressed pressure gas molecules, compressed extraction solvent molecules, or both.

The pressure adjustment procedure includes introducing a pressure gas into extraction chamber 110 to bring the pressure inside extraction chamber 110 to an upper pressure that equals or exceeds a predetermined threshold pressure. FIG. 5 displays device 100 in a pre-pressure gas configuration 92 and a pressurized configuration 94. Pre-pressure gas configuration 92 displays device 100 prior to any pressure gas being introduced. Pressurized configuration 94 displays device 100 after sufficient pressure gas has been introduced to increase the pressure inside extraction chamber 110 to a pressure that equals or exceeds the predetermined threshold pressure.

FIG. 5 additionally displays a first magnified view 93 of lavender 101 and extraction solvent 102 when device 100 is in pre-pressure gas configuration 92. FIG. 5 also displays a second magnified view 95 of lavender 101, extraction solvent 102, and compressed pressure gas molecules 98 when device 100 is in pressurized configuration 94.

As FIG. 5 illustrates in second magnified view 95, the increased pressure provided by introducing the pressure gas produces a high density of compressed pressure gas molecules 98 in extraction solvent 102. As FIG. 5 shows, the relatively small size and increased density of compressed pressure gas molecules 98 increases the number of molecules that bind to the surface area of the plant biomass. By increasing the number of molecules that bind to the plant biomass and/or increasing the surface area of the plant biomass to which molecules bind, one may increase the extent to which molecules may rupture the plant structural elements when they expand. As a result, the yield of solute extracted from the plant biomass may be increased.

The relatively small size of compressed pressure gas molecules 98 may, in some examples, penetrate gaps, openings, or other voids in the plant biomass. When compressed pressure gas molecules 98 penetrate the plant biomass, they may be more effective in breaking the structural elements of the plant biomass when they expand.

One suitable pressure gas is nitrous oxide; nitrous oxide has been found to yield particularly efficient and desirable extraction results when used as the pressure gas. Nitrous oxide is desirable because it emits a faint, sweet odor, which does not adversely affect the final essential oil product. Additionally, the molecular size and linear structure of nitrous oxide facilitates rupturing plant structural components. It is believed nitrous oxide molecules compress sufficiently under threshold pressure to bind with or enter plant structural components. It is further believed nitrous oxide molecules then expand when the pressure inside extraction chamber 110 returns to 0 psi; thus, rupturing plant structural components, including cell walls and trichomes.

In additional examples, suitable pressure gasses may include inert gases, such as nitrogen or noble gases.

In some examples, the threshold pressure is 25 psi or more. When nitrous oxide is used as a pressure gas, 25 psi has been found to produce particularly satisfactory results. In further examples, the threshold pressure may be any pressure above ambient pressure sufficient to rupture plant structural components, including cell walls and trichomes.

In some examples, the pressure gas is introduced by fluidly communicating the pressure gas into the extraction chamber through the pressure gas inlet valve. In some examples, the pressure gas is fluidly communicated through a fluid-tight pressure gas conduit, such as pressure gas conduit 150. In some examples, the pressure gas is further fluidly communicated through dispersal member 160 after passage through pressure gas conduit 150.

FIG. 5 illustrates device 100 in pressurized configuration 94, wherein sufficient gas has been introduced to compress the pressure gas molecules. FIG. 5 additionally illustrates additional pressure gas being introduced into device 100. As FIG. 5 shows, pressure gas 89 enters extraction container 109 through pressure gas inlet 140. As FIG. 5 illustrates, pressure gas 89 then flows through pressure gas conduit 150 and is released into extraction chamber 110 near bottom surface 112 through dispersal openings 164 of dispersal member 160.

By introducing pressure gas 89 proximate bottom surface 112, pressure gas 89 is encouraged to mix with extraction solvent 102. This may increase the number of pressure gas molecules exposed to the contained plant biomass. Increasing the number of pressure gas molecules exposed to the plant biomass increases the efficiency of breaking the structural elements of plant biomass and increases the yield of solute extracted therefrom.

In other examples, the extraction solvent, rather than the pressure gas, is configured to bind to the plant biomass contained in extraction chamber 110. In such examples, the molecules of the extraction solvent may compress as pressure gas increases the pressure within extraction chamber 110, allowing a larger number of molecules to bind to the plant biomass. Similarly, the extraction solvent may define a greater density at the higher pressures, causing additional extraction solvent molecules to bind to the plant biomass.

After introducing the pressure gas to adjust the internal pressure in the extraction chamber to at least a predetermined upper pressure, the pressure adjustment procedure further includes removing at least a portion of the pressure gas from the extraction chamber to adjust the internal pressure in the extraction chamber to a predetermined lower pressure. FIG. 5 illustrates device 100 in an expanded configuration 96 after pressure gas has been released to lower the pressure inside extraction chamber 110 to a predetermined lower pressure. FIG. 5 additionally displays a third magnified view 97 of lavender 101, extraction solvent 102, and expanded pressure gas molecules 99 when device 100 is in expanded configuration 96.

As third magnified view 97 shows, pressure gas molecules bound to plant biomass are configured to break the structural elements of the plant biomass as they expand. As seen in third magnified view 97, the structural elements of lavender 101 are ruptured to cause solute molecules 87 to break from lavender 101 and mix with extraction solvent 102.

In some examples, the extraction solvent defines a material that is configured to dissolve the plant biomass. In such examples, expanding the pressure gas molecules bound to the plant biomass may increase the speed with which solute breaks from the plant biomass and dissolves in the extraction solvent.

FIG. 5 illustrates the pressure gas being released from extraction chamber 110 by opening pressure release valve 130 and allowing fluid to pass from extraction chamber 110 to the exterior of extraction container 109. Some examples may additionally or alternatively include a pressure gauge, similar to pressure gauge 122. When using a pressure gauge, a user may leave pressure release valve 130 open until the pressure gauge reads the predetermined lower pressure.

As FIG. 8 shows, the pressure adjustment procedure is repeated one or more times at step 250. In some examples, the pressure adjustment procedure is repeated for a predetermined duration selected to extract a satisfactory yield of extracted solute from the plant biomass. In some examples, the pressure adjustment procedure is repeated a predetermined number of times selected to extract a satisfactory yield of extracted solute from the plant biomass.

In repeating the pressure adjustment procedure, device 100 is repeatedly adjusted between pressurized configuration 94 and expanded configuration 96. In repeating the procedure, pressure gas is introduced until extraction chamber 110 reaches an upper predetermined pressure and, upon reaching the upper predetermined pressure, pressure gas is released until extraction chamber 110 reaches the lower predetermined pressure. Upon reaching the lower predetermined pressure, pressure gas may again be introduced into extraction chamber 110 to begin the second iteration of the pressure adjustment procedure.

Each iteration results in the pressure gas rupturing the plant biomass's structural components, including cell walls and trichomes, with each expansion/release phase. Indeed, the repetitive pressurizing/releasing procedure has been found to be surprisingly effective at rupturing plant structural material and extracting solute from plant biomass without exposing the plant biomass to high temperatures and without requiring elaborate condensation equipment. As FIG. 5 shows, rupturing the plant biomass's structural elements and dissolving solute in the extraction solvent produces a second mixture 54 including plant biomass, extracted solute, and the extraction solvent.

In some examples, alternating between the threshold pressure and 0 psi internal pressure for approximately 10 minutes has been found to produce particularly satisfactory results. Pressure fluctuation times may increase or decrease depending on the threshold pressure selected.

As seen in FIG. 8, extraction chamber 110 is unsealed to expose the second mixture to atmospheric pressure at step 260. In some examples, unsealing extraction chamber 110 includes removing lid 170, pressure gas conduit 150, and/or dispersal member 160.

As FIG. 8 illustrates, the plant biomass is discarded to produce a third mixture including the extraction solvent and the extracted solute at step 270. In some examples, discarding the plant biomass may include fluidly communicating the second mixture to a vessel through a filter defining a porosity selected to allow passage of the extraction solvent and the extracted solute while restricting passage of the plant biomass.

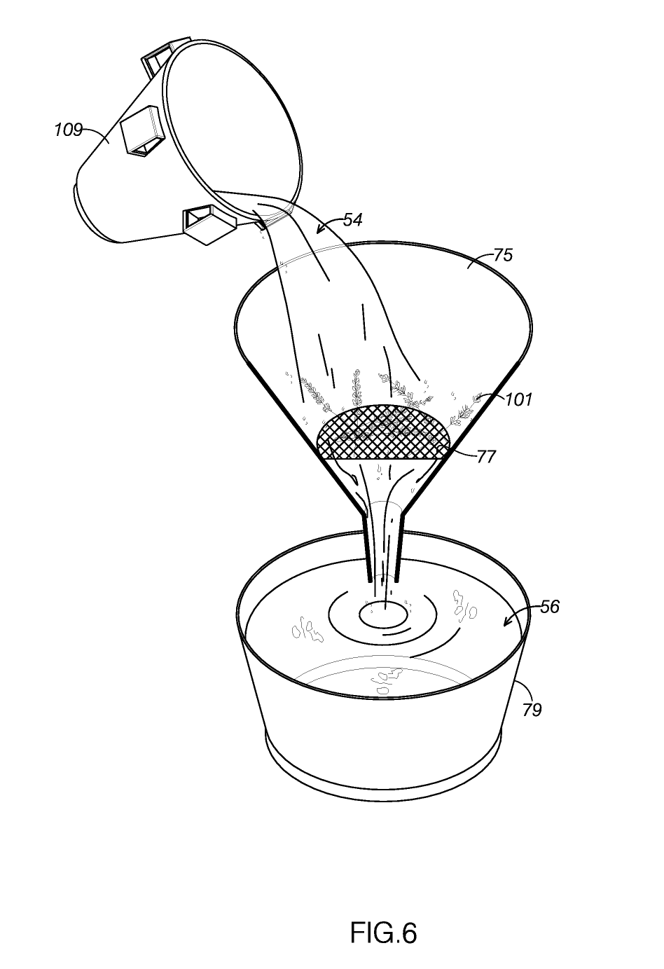

FIG. 6 illustrates an example of the plant biomass being discarded. As FIG. 6 shows, second mixture 54 is poured from extraction container 109 into a funnel 75. As FIG. 6 shows, funnel 75 defines a wire mesh filter 77 through which fluid must pass through when communicated from the input of funnel 75 to the output of funnel 75. Wire mesh filter 77 includes a plurality of openings sized to allow passage of the extraction solvent and extracted solute while trapping lavender 101. The trapped lavender 101 may simply be discarded. As FIG. 6 shows, passing the second mixture through wire mesh filter 77 produces a third mixture 56 in a mixing vessel 79, third mixture 56 containing only the extraction solvent and extracted solute.

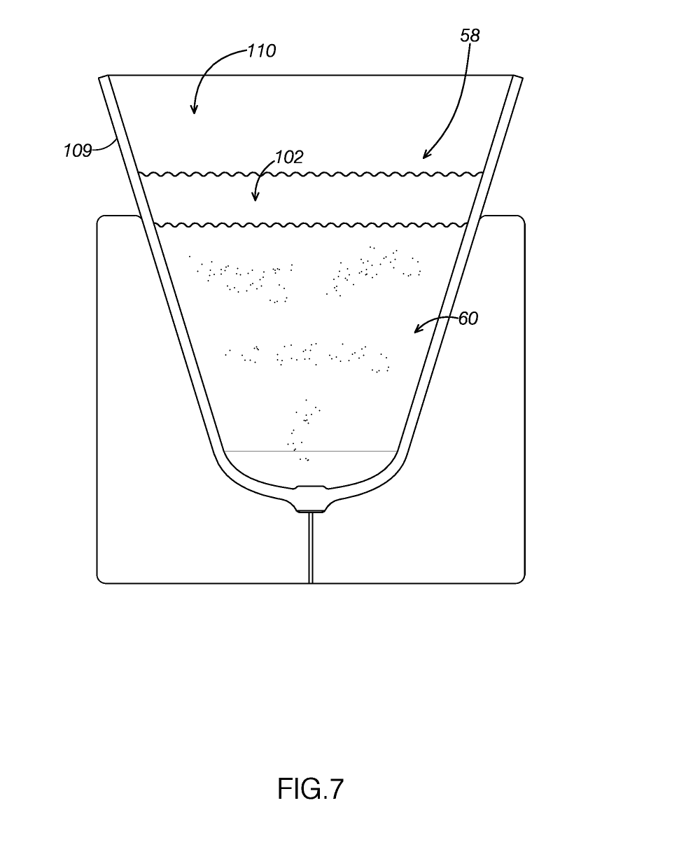

As FIG. 8 shows, a transfer oil is introduced into the third mixture to create a fourth mixture containing the extraction solvent, transfer oil, and extracted solute at step 280. FIG. 7 illustrates an example wherein a fourth mixture 58 has been reintroduced into extraction container 109 after being mixed. Combining the extraction solvent with the transfer oil “pulls” or extracts the plant essential oils, including extracted solute, from the extraction solvent into the transfer oil. Suitable transfer oils include olive oil, including virgin olive oil, peanut oil, canola oil, or vegetable oil.

In some examples, introducing the transfer oil includes vigorously agitating the fourth mixture for several minutes at step 290. Agitating the fourth mixture may increase the effectiveness and efficiency with which the transfer oil “pulls” or extracts the plant essential oils, including extracted solute, from the third mixture.

As seen in FIG. 8, the extraction solvent is removed from the fourth mixture to produce an essential oil mixture including the transfer oil and the extracted solute at step 290. In some examples, removing the extraction solvent from the fourth mixture includes resting the vessel or container containing the fourth mixture for a predetermined period of time sufficient to allow the extraction solvent to separate from the transfer oil. FIG. 7, for example, illustrates extraction container 109 containing fourth mixture 58 that has been rested to allow an essential oil mixture 60 to separate from extraction solvent 102. When resting, the extracted solute tends to remain mixed with the transfer oil, resulting in a two-level separated mixture including extraction solvent 102 in a first level separated from the transfer oil and extracted solute in solution on a second level.

In some examples, removing the extraction solvent from the fourth mixture may include reintroducing the fourth mixture into an extraction container similar to extraction chamber 110 and opening the drain port of the extraction container until substantially all of the essential oil mixture is removed from the extraction chamber while the extraction solvent remains in the extraction chamber.

FIG. 7, for example, illustrates an example wherein essential oil mixture 60 has been separated from extraction solvent 102. As FIG. 7 shows, essential oil mixture 60 is denser than extraction solvent 102, which causes essential oil mixture 60 to separate to the bottom of extraction chamber 110 after resting. Because drain port 195 is positioned on bottom surface 112 of extraction chamber 110, drain port 195 is configured to drain whatever fluid is disposed on the bottom of extraction chamber 110. At this point, opening drain port 195 will tend to drain only the lower essential oil mixture 60 because it is located at the bottom of extraction chamber 110. Drain port 195 will drain extraction solvent 102 only after substantially all of essential oil mixture 60 has been drained.

In some examples, a small portion of essential oil mixture may remain in the container or vessel after draining. Indeed, including extraction solvent in the final essential oil mixture may contaminate the essential oil and produce an unacceptable product. Accordingly, sacrificing a slight percentage of yield in exchange for the assurance that the final essential oil mixture includes a minimal amount of extraction solvent is prudent. As a result, the essential oil mixture should stop being drained when there is a small portion of essential oil mixture in the container rather than when all of the essential oil mixture has been drained.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method for extracting solute from plant biomass, comprising:
placing plant biomass in an extraction chamber;
introducing an extraction solvent into the extraction chamber to create a first mixture, the first mixture including plant biomass and the extraction solvent;
sealing the extraction chamber at a predetermined initial pressure;
performing a pressure adjustment procedure on the first mixture in the extraction chamber, the pressure adjustment procedure including:
introducing a pressure gas into the extraction chamber to adjust the internal pressure in the extraction chamber to at least a predetermined upper pressure that exceeds a predetermined threshold pressure;
removing at least a portion of the pressure gas from the extraction chamber to adjust the internal pressure in the extraction chamber to a predetermined lower pressure;
repeating the pressure adjustment procedure a one or more times to sufficiently to rupture structural components of the plant biomass and to extract solute from the plant biomass to create a second mixture, the second mixture including plant biomass, the extraction solvent, and the extracted solute; and
discarding the plant biomass to produce a third mixture, the third mixture including the extraction solvent, and the extracted solute.

2. The method of claim 1, wherein the predetermined upper pressure is above an ambient pressure present in an exterior environment proximate the extraction chamber.

3. The method of claim 1, wherein discarding the plant biomass to produce a mixture of extraction solvent and extracted solute includes fluidly communicating the second mixture to a vessel through a filter defining a porosity selected to allow passage of the extraction solvent and extracted solute while restricting passage of the plant biomass to produce the third mixture in the mixing vessel.

4. The method of claim 2, further comprising introducing a transfer oil into third mixture to create a fourth mixture including the transfer oil, the extraction solvent, and the extracted solute.

5. The method of claim 4, further comprising removing the extraction solvent from the fourth mixture to produce an essential oil mixture containing the transfer oil and the extracted solute.

6. The method of claim 5, wherein:
introducing the transfer oil into the vessel containing the mixture of the third mixture to create the fourth mixture includes agitating vigorously the mixing vessel containing the fourth mixture; and
removing the extraction solvent from the fourth mixture includes resting the fourth mixture for a predetermined period of time sufficient to allow the extraction solvent to separate from the transfer oil.

7. The method of claim 6, wherein the transfer oil defines olive oil.

8. The method of claim 6, wherein the pressure gas compresses at the threshold pressure a predetermined compression amount selected to increase the surface area of the plant biomass to which pressure gas molecules bind.

9. The method of claim 8, wherein the pressure gas defines nitrous oxide.

10. The method of claim 6, wherein the threshold pressure defines a predetermined compressing pressure selected to compresses the pressure gas a predetermined compression amount selected to bind with plant structural components.

11. The method of claim 10, wherein:
the threshold pressure is 25 pounds per square inch; and
the pressure gas defines nitrous oxide.

12. The method of claim 6, wherein:
the extraction chamber includes a drain port disposed on a bottom surface of the extraction chamber, the drain port being configured to selectively open to allow passage of the essential oil mixture from the extraction chamber; and
removing the extraction solvent from the transfer oil includes:
reintroducing the fourth mixture into the extraction chamber; and
opening the drain port until substantially all of the essential oil mixture is removed from the extraction chamber while the extraction solvent remains in the extraction chamber.

13. The method of claim 1, wherein:
sealing the extraction chamber includes fitting a substantially fluid-tight lid over the top of the extraction chamber, the lid including a pressure gas inlet configured to selectively allow passage of the pressure gas into the extraction chamber; and
introducing the pressure gas into the extraction chamber includes:
opening the pressure gas inlet; and
fluidly communicating the pressure gas from a pressure gas source into the extraction chamber through the pressure gas inlet.

14. The method of claim 13, wherein fluidly communicating the pressure gas through the pressure gas inlet includes fluidly communicating the pressure gas through a fluid-tight pressure gas conduit, the pressure gas conduit being:
in fluid communication with the pressure gas source through the pressure gas inlet at an input end; and
extending to an output end proximate the bottom of the extraction container, the output end configured to communicate fluid from the pressure gas inlet to the bottom of the extraction container.

15. The method of claim 14, wherein:
the pressure gas conduit is coupled with a pressure gas dispersal member, the pressure gas dispersal member defining:
a conduit fitting configured to fluid-tightly couple with the pressure gas conduit to place the pressure gas dispersal member in fluid communication with the pressure gas conduit;
a rigid supporting member that extends from the conduit fitting at an obtuse angle, the supporting member defining a supporting edge configured to rest on the bottom of the extraction chamber to support the pressure gas dispersal member in an upright position; and
a dispersal opening abutting the supporting member of the dispersal member configured to allow the passage of fluid received from the pressure gas conduit into the extraction chamber; and
fluidly communicating the pressure gas through the pressure gas inlet includes fluidly communicating the pressure gas through the dispersal opening.

16. The method of claim 13, wherein:
a pressure release valve is received by the lid, the pressure release valve being configured to selectively open to allow passage of the pressure gas from the top of the extraction chamber; and
removing at least a portion of the pressure gas from the extraction chamber includes opening the pressure release valve.

17. The method of claim 16, wherein:
a pressure gauge is received by the lid in fluid communication with the extraction chamber, the pressure gauge configured detect the pressure at the top of the extraction chamber; and
removing the at least a portion of the pressure gas from the extraction chamber includes opening the pressure release valve until the pressure gauge reads the predetermined lower pressure.

18. A method for extracting solute from plant biomass, comprising:
placing a contained quantity of plant biomass in an extraction chamber;
introducing a quantity of extraction solvent sufficient to submerge the contained quantity of plant biomass in the introduced extraction solvent to create a mixture of plant biomass and extraction solvent;
sealing the extraction chamber at a predetermined initial pressure;
performing a pressure adjustment procedure on the contents of the extraction chamber, the pressure adjustment procedure including:
introducing a quantity of input gas into the extraction chamber to adjust the internal pressure in the extraction chamber to at least a predetermined threshold pressure;
removing a quantity of output gas from the extraction chamber to adjust the internal pressure in the extraction chamber to the predetermined initial pressure;
repeat the pressure adjustment procedure for a predetermined duration determined to rupture plant structural components of the plant biomass to create a mixture of plant biomass, extraction solvent, and extracted solute; and
discarding the plant biomass to produce a mixture of extraction solvent and extracted solute.

19. A method for extracting solute from plant biomass, comprising:
providing an extraction chamber containing plant biomass and a quantity of extraction solvent sufficient to submerge the contained quantity of plant biomass in the introduced extraction solvent to create a mixture of plant biomass and extraction solvent;
sealing the extraction chamber at a predetermined initial pressure;
performing a pressure adjustment procedure on the contents of the extraction chamber, the pressure adjustment procedure including:
introducing a quantity of pressure gas into the extraction chamber to adjust the internal pressure in the extraction chamber to at least a predetermined upper pressure;
removing a quantity of pressure gas from the extraction chamber to adjust the internal pressure in the extraction chamber to the predetermined lower pressure;
repeat the pressure adjustment procedure a predetermined number of times determined to rupture plant structural components of the plant biomass to create a mixture of plant biomass, extraction solvent, and extracted solute; and
discarding the plant biomass to produce a mixture of extraction solvent and extracted solute.
